(19) United States
(12) Patent Application Publication
(10) Pub. No.: US 2026/0281930 A1
(43) Pub. Date: Sep. 17, 2026

(54) METHODS AND APPARATUSES FOR SRS CONFIGURATION WITH VALIDITY AREA

(71) Applicant: LENOVO (BEIJING) LIMITED, Beijing (CN)

(72) Inventors: Jie HU, Beijing (CN); Jing HAN, Beijing (CN); Lihua YANG, Beijing (CN)

(21) Appl. No.: 19/168,040

(22) PCT Filed: Jul. 12, 2023
(86) PCT No.: PCT/CN2023/107064

§ 371 Date: Sep. 23, 2025

(51) Int. Cl. H04W 56/00; H04B 17/318; H04L 5/00

(52) U.S. Cl. CPC H04W 56/0045; H04B 17/328; H04L 5/0051; H04L 5/0053

(57) ABSTRACT

Various aspects of the present disclosure relate to methods and apparatuses for sounding reference signal (SRS) configuration with validity area. According to an embodiment of the present disclosure, a user equipment (UE) can include: at least one memory; and at least one processor coupled with the at least one memory and configured to cause the UE to: receive a first configuration including an area-specific time alignment timer associated with an SRS validity area; and transmit an indication to acquire, activate, or deactivate a second configuration associated with the SRS validity area when the UE is in a non-connected state, wherein the second configuration includes an SRS configuration, or a time alignment configuration, or a timing advance (TA) command.

### TECHNICAL FIELD

The present disclosure relates to wireless communications, and more specifically to methods and apparatuses for sounding reference signal (SRS) configuration with validity area.

### BACKGROUND

A wireless communications system may include one or multiple network communication devices, such as base stations (BSs), which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the methods and apparatuses described herein may include a UE for wireless communication. The UE may include: at least one memory; and at least one processor coupled with the at least one memory and configured to cause the UE to: receive a first configuration including an area-specific time alignment timer associated with an SRS validity area; and transmit an indication to acquire, activate, or deactivate a second configuration associated with the SRS validity area when the UE is in a non-connected state, wherein the second configuration includes an SRS configuration, or a time alignment configuration, or a timing advance (TA) command.

In some implementations of the UE described herein, the indication is an SRS configuration request or SRS activation request, and the at least one processor is further configured to cause the UE to receive, in response to the SRS configuration request or SRS activation request, the TA command for a random access procedure that is successfully completed.

In some implementations of the UE described herein, the indication is a TA command request, and the at least one processor is further configured to cause the UE to receive the TA command in response to the indication.

In some implementations of the UE described herein, the TA command request is transmitted periodically based on a periodicity, or transmitted based on an event, or transmitted based on the UE's implementation; and the periodicity or the event is configured or pre-configured to the UE, or is pre-defined.

In some implementations of the UE described herein, the event is that a difference of a reference signal receiving power (RSRP) value relative to a reference value is greater than a first threshold within a first time period or a moving speed of the UE is greater than a second threshold within a second time period; and the first threshold, the first time period, the second threshold, or the second time period is configured or pre-configured to the UE, or is pre-defined.

In some implementations of the UE described herein, the at least one processor is further configured to cause the UE to monitor the TA command from a serving BS within a time period after performing each SRS transmission.

In some implementations of the UE described herein, the at least one processor is further configured to cause the UE to: in response to receiving the TA command, start or restart the area-specific time alignment timer.

In some implementations of the UE described herein, the at least one processor is further configured to cause the UE to: start or restart the area-specific time alignment timer in response to receiving an indication for starting the area-specific time alignment timer; or stop the area-specific time alignment timer in response to receiving an indication for stopping the area-specific time alignment timer.

In some implementations of the UE described herein, the at least one processor is further configured to cause the UE to: transmit the indication in response to expiration of the area-specific time alignment timer and an SRS configuration being unreleased, wherein the indication is a deactivation request to deactivate the unreleased SRS configuration; receive, in response to the deactivation request, a deactivation response to deactivate the unreleased SRS configuration; and deactivate the unreleased SRS configuration.

In some implementations of the UE described herein, the at least one processor is further configured to cause the UE to: release the unreleased SRS configuration when there is no SRS transmission during a time period after the area-specific time alignment timer expires.

In some implementations of the UE described herein, the at least one processor is further configured to cause the UE to: transmit the indication in the case that the area-specific time alignment timer expires and an SRS configuration is unreleased, wherein the indication is an activation request to activate the unreleased SRS configuration, and wherein the activation request indicates: the unreleased SRS configuration and a cause value; or a service type or a quality of service (QoS) requirement.

In some implementations of the UE described herein, the at least one processor is further configured to cause the UE to: transmit the indication in the case that the area-specific time alignment timer expires and an SRS configuration is unreleased, wherein the indication is a request to acquire the time alignment configuration which indicates another area-specific time alignment timer, and the request indicates the unreleased SRS configuration and a cause value.

In some implementations of the UE described herein, the at least one processor is further configured to cause the UE to: receive a paging message in the case that the area-specific time alignment timer expires; and transmit the indication after receiving the paging message, wherein the indication is a request to acquire the time alignment configuration which indicates another area-specific time alignment timer.

In some implementations of the UE described herein, the at least one processor is further configured to cause the UE to: stop an SRS transmission and release an SRS configuration in response to expiration of the area-specific time alignment timer; and transmit the indication in the case that there is a pending location service, wherein the indication is a request to acquire a new SRS configuration, and the request indicates a cause value.

In some implementations of the UE described herein, the at least one processor is further configured to cause the UE to: maintain one of the area-specific time alignment timer and a cell-specific time alignment timer at the same time based on a received SRS configuration; or invalidate a cell-specific time alignment configuration in response to receiving the first configuration; or not receive a cell specific SRS configuration and a validity area specific SRS configuration at the same time; or not activate a cell specific SRS configuration and a validity area specific SRS configuration at the same time.

In some implementations of the UE described herein, the at least one processor is further configured to cause the UE to: receive a third configuration indicating a cell-specific time alignment timer; and start or restart the area-specific time alignment timer and the cell-specific time alignment timer simultaneously in response to receiving a TA command or an indication for starting the area-specific time alignment timer or the cell-specific time alignment timer.

In some implementations of the UE described herein, in the case that the cell-specific time alignment timer expires but the area-specific time alignment timer is running, the at least one processor is further configured to cause the UE to: continue an SRS transmission; determine an uplink (UL) unsynchronization for cell specific UL transmission(s); stop all cell specific UL transmission(s); or initiate a TA command update or request a cell-specific time alignment configuration when a cell specific UL transmission occurs.

In some implementations of the UE described herein, in the case that the UE reselects to a new cell within the SRS validity area and different from a cell associated with the cell-specific time alignment timer, the at least one processor is further configured to cause the UE to: stop or restart the cell-specific time alignment timer; and keep the area-specific time alignment timer running.

In some implementations of the UE described herein, in the case that the area-specific time alignment timer expires, the at least one processor is further configured to cause the UE to: stop an SRS transmission; and stop the cell-specific time alignment timer.

In some implementations of the UE described herein, the first configuration further indicates multiple SRS configurations for multiple SRS validity areas and is received via a radio resource control (RRC) release message or a positioning system information block (posSIB) message.

In some implementations of the UE described herein, the first configuration further indicates an SRS configuration of the multiple SRS configurations used by the UE; or the at least one processor is further configured to cause the UE to determine an SRS configuration of the multiple SRS configurations used by the UE based on a cell identity (ID) and validity area information indicating the multiple SRS validity areas.

In some implementations of the UE described herein, the indication is an activation request to activate an SRS configuration of the multiple SRS configurations.

In some implementations of the UE described herein, the at least one processor is further configured to cause the UE to receive an activation response in response to the activation request, wherein the activation response indicates an SRS configuration of the multiple SRS configurations and a TA command used by the UE.

In some implementations of the UE described herein, the activation request indicates the SRS configuration, and the at least one processor is further configured to cause the UE to: receive an acknowledgement (ACK) in response to the activation request in the case that the indicated SRS configuration is available; or receive an activation response in response to the activation request, wherein the activation response indicates a different SRS configuration of the multiple SRS configurations in the case that the indicated SRS configuration is unavailable.

In some implementations of the UE described herein, the activation request indicates a cause value.

Some implementations of the methods and apparatuses described herein may include a processor for wireless communication. The processor may include: at least one controller coupled with at least one memory and configured to cause the processor to: receive a first configuration including an area-specific time alignment timer associated with an SRS validity area; and transmit an indication to acquire, activate, or deactivate a second configuration associated with the SRS validity area when a UE including the processor is in a non-connected state, wherein the second configuration includes an SRS configuration, or a time alignment configuration, or a TA command.

Some implementations of the methods and apparatuses described herein may include a BS for wireless communication. The BS may include: at least one memory; and at least one processor coupled with the at least one memory and configured to cause the BS to: transmit, to a UE, a first configuration including an area-specific time alignment timer associated with an SRS validity area; and receive an indication to acquire, activate, or deactivate a second configuration associated with the SRS validity area when the UE is in a non-connected state, wherein the second configuration includes an SRS configuration, or a time alignment configuration, or a TA command.

In some implementations of the BS described herein, the indication is an SRS configuration request or SRS activation request, and the at least one processor is further configured to cause the BS to transmit, in response to the SRS configuration request or SRS activation request, the TA command for a random access procedure that is successfully completed.

In some implementations of the BS described herein, the indication is a TA command request, and the at least one processor is further configured to cause the BS to transmit the TA command in response to the indication.

In some implementations of the BS described herein, the TA command request is received periodically based on a periodicity or received based on an event; and the periodicity or the event is configured or pre-configured to the UE, or is pre-defined.

In some implementations of the BS described herein, the event is that a difference of an RSRP value relative to a reference value is greater than a first threshold within a first time period or a moving speed of the UE is greater than a second threshold within a second time period; and the first threshold, the first time period, the second threshold, or the second time period is configured or pre-configured to the UE, or is pre-defined.

In some implementations of the BS described herein, the at least one processor is further configured to cause the BS to: transmit, to the UE, an indication for starting the area-specific time alignment timer or an indication for stopping the area-specific time alignment timer.

In some implementations of the BS described herein, the at least one processor is further configured to cause the BS to: receive the indication in response to expiration of the area-specific time alignment timer and an SRS configuration being unreleased, wherein the indication is a deactivation request to deactivate the unreleased SRS configuration; transmit, in response to the deactivation request, a deactivation response to deactivate the unreleased SRS configuration; and deactivate the unreleased SRS configuration.

In some implementations of the BS described herein, the at least one processor is further configured to cause the BS to: release the unreleased SRS configuration when there is no SRS transmission during a time period after the area-specific time alignment timer expires.

In some implementations of the BS described herein, the at least one processor is further configured to cause the BS to: receive the indication in the case that the area-specific time alignment timer expires and an SRS configuration is unreleased, wherein the indication is an activation request to activate the unreleased SRS configuration, and wherein the activation request indicates: the unreleased SRS configuration and a cause value; or a service type or a QoS requirement.

In some implementations of the BS described herein, the at least one processor is further configured to cause the BS to: receive the indication in the case that the area-specific time alignment timer expires and an SRS configuration is unreleased, wherein the indication is a request to acquire the time alignment configuration which indicates another area-specific time alignment timer, and the request indicates the unreleased SRS configuration and a cause value.

In some implementations of the BS described herein, the at least one processor is further configured to cause the BS to: transmit a paging message in the case that the area-specific time alignment timer expires; and receive the indication after transmitting the paging message, wherein the indication is a request to acquire the time alignment configuration which indicates another area-specific time alignment timer.

In some implementations of the BS described herein, the at least one processor is further configured to cause the BS to: release an SRS configuration in response to expiration of the area-specific time alignment timer; and receive the indication in the case that there is a pending location service, wherein the indication is a request to acquire a new SRS configuration, and the request indicates a cause value.

In some implementations of the BS described herein, the at least one processor is further configured to cause the BS to: maintain one of the area-specific time alignment timer and a cell-specific time alignment timer at the same time based on a transmitted SRS configuration; or invalidate a cell-specific time alignment configuration in response to transmitting the first configuration; or not transmit a cell specific SRS configuration and a validity area specific SRS configuration at the same time; or not activate a cell specific SRS configuration and a validity area specific SRS configuration at the same time.

In some implementations of the BS described herein, the first configuration further indicates multiple SRS configurations for multiple SRS validity areas and is transmitted via an RRC release message or a posSIB message.

In some implementations of the BS described herein, the first configuration further indicates an SRS configuration of the multiple SRS configurations used by the UE; or the at least one processor is further configured to cause the BS to determine an SRS configuration of the multiple SRS configurations used by the UE based on a cell ID and validity area information indicating the multiple SRS validity areas.

In some implementations of the BS described herein, the indication is an activation request to activate an SRS configuration of the multiple SRS configurations.

In some implementations of the BS described herein, the at least one processor is further configured to cause the BS to transmit an activation response in response to the activation request, wherein the activation response indicates an SRS configuration of the multiple SRS configurations and a TA command used by the UE.

In some implementations of the BS described herein, the activation request indicates the SRS configuration, and the at least one processor is further configured to cause the BS to: transmit an ACK in response to the activation request in the case that the indicated SRS configuration is available; or transmit an activation response in response to the activation request, wherein the activation response indicates a different SRS configuration of the multiple SRS configurations in the case that the indicated SRS configuration is unavailable.

In some implementations of the BS described herein, the activation request indicates a cause value.

Some implementations of the methods and apparatuses described herein may include a method performed by a UE. The method may include: receiving a first configuration including an area-specific time alignment timer associated with an SRS validity area; and transmitting an indication to acquire, activate, or deactivate a second configuration associated with the SRS validity area when the UE is in a non-connected state, wherein the second configuration includes an SRS configuration, or a time alignment configuration, or a TA command.

Some implementations of the methods and apparatuses described herein may include a method performed by a BS. The method may include: transmitting, to a UE, a first configuration including an area-specific time alignment timer associated with an SRS validity area; and receiving an indication to acquire, activate, or deactivate a second configuration associated with the SRS validity area when the UE is in a non-connected state, wherein the second configuration includes an SRS configuration, or a time alignment configuration, or a TA command.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an example of a wireless communications system in accordance with aspects of the present disclosure.

FIG. 2 illustrates an exemplary area-specific time alignment timer in accordance with aspects of the present disclosure.

FIG. 3 illustrates a flowchart of an exemplary method performed by a UE and a BS in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a BS in accordance with aspects of the present disclosure.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) long-term evolution (LTE) and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

Aspects of the present disclosure are described in the context of a wireless communications system.

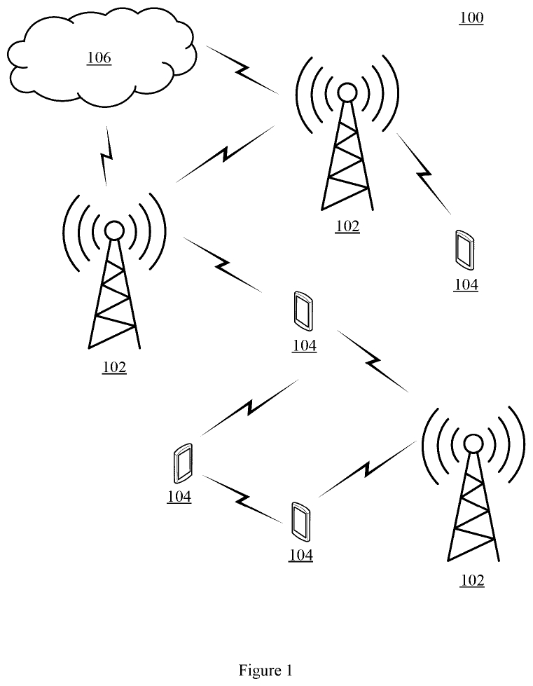

FIG. 1 illustrates an example of a wireless communications system 100 in accordance with aspects of the present disclosure. The wireless communications system 100 may include one or more network equipments (NEs) (e.g., BSs) 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NEs 102 may communicate with each other directly. In some other implementations, the NEs 102 may communicate with each other indirectly (e.g., via the CN 106. In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

SRS, which is an uplink reference signal transmitted from a UE to a BS, may be used for UL positioning. SRS positioning validity area (also referred to as SRS validity area or validity area) for UL positioning in a non-connected state (e.g., RRC_INACTIVE state or RRC_IDLE state) may avoid SRS configuration upon cell reselection and thus is recommended to be used in low power high accuracy positioning (LPHAP). For example, a UE may be configured with an SRS configuration along with an SRS validity area, wherein the SRS validity area includes one or more cells (e.g., a list of cells) in which the SRS configuration is valid, and the one or more cells include a cell where the UE receives the SRS configuration. If the UE reselects to another cell within the SRS validity area during an SRS transmission (e.g., positioning SRS transmission) when the UE is in the non-connected state, the UE may continue the SRS transmission without SRS reconfiguration. In some embodiments of the present disclosure, the SRS configuration with the SRS validity area may be configured to the UE via an RRC release message (e.g., RRCRelease as specified in TS 38.331) or a posSIB message. In some embodiments of the present disclosure, multiple SRS configurations for multiple SRS validity areas may be configured to the UE via an RRC release message or a posSIB message.

In legacy, a UE may be configured with a time alignment timer (e.g., denoted as: inactivePosSRS-TimeAlignmentTimer) which may control how long a medium access control (MAC) entity of the UE considers an SRS transmission within a cell to be uplink time aligned when the UE is in the non-connected state. Such time alignment timer may be referred to as a cell-specific time alignment timer. The UE may start or restart the cell-specific time alignment timer when receiving a TA command, and may stop the cell-specific time alignment timer when receiving an indication from the BS (e.g., the BS transmits the indication to the UE via upper layer signaling and the MAC entity of the UE receives the indication from an upper layer of the UE) or when reselecting to a new cell which is different from the cell in which the UE receives the cell-specific time alignment timer. When the cell-specific time alignment timer expires, the UE may notify the RRC layer to release positioning SRS configuration(s) for the non-connected state. According to implementations of the present disclosure, to maintain a valid TA for SRS transmission in the non-connected state and corresponding to the validity area specific SRS configuration, i.e., the SRS configuration with validity area for positioning SRS transmission in the non-connected state, an area-specific time alignment timer (also referred to as SRS validity area-specific time alignment timer) for a UE may be defined to control the validity area specific SRS transmission within the SRS validity area in the non-connected state. For example, the area-specific time alignment timer may control how long a MAC entity of the UE considers the SRS transmission within the SRS validity area to be uplink time aligned.

In some embodiments of the present disclosure, the UE may start or restart the area-specific time alignment timer when it receives a TA command. In some embodiments of the present disclosure, the UE may stop the area-specific time alignment timer when it reselects to a cell out of the SRS validity area. In some embodiments of the present disclosure, the UE may stop the SRS transmission when the area-specific time alignment timer expires.

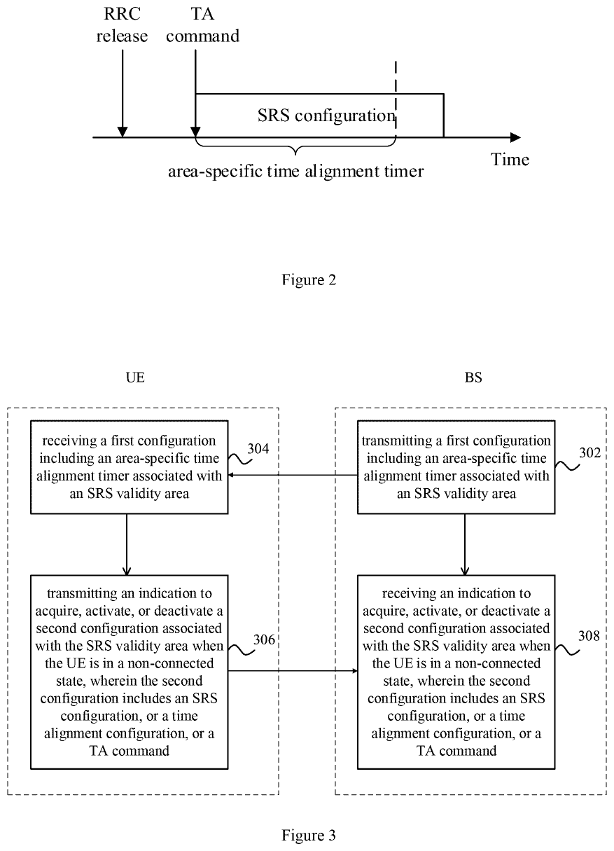

FIG. 2 illustrates an exemplary area-specific time alignment timer in accordance with aspects of the present disclosure.

Referring to FIG. 2, a UE may receive an SRS configuration with an SRS validity area via an RRC release message. The SRS configuration may also include an area-specific time alignment timer. The UE may enter a non-connected state after receiving the RRC release message. In the non-connected state, in response to receiving a TA command, the UE may start or restart the area-specific time alignment timer and perform an SRS transmission based on the SRS configuration. When the area-specific time alignment timer expires, the UE may stop the SRS transmission, even though it is still within the SRS validity area.

There are some issues which need to be solved when designing an SRS configuration with an SRS validity area and an area-specific time alignment timer.

Issue #1 is how to acquire a TA command. As stated above, a UE may start or restart the area-specific time alignment timer when it receives a TA command. In legacy, a TA command is received in a random access response message for a serving cell. However, the UE may not perform SRS transmission all the time, and the network may not know in which cell the UE currently camps if the UE does not initiate an uplink transmission when it is within the SRS validity area. Thus, the UE may not receive the TA command from the network over a long period of time if no uplink request is initiated as legacy. Given this, how to acquire a TA command needs to be solved.

Issue #2 is how to deal with an SRS configuration associated with an SRS validity area (i.e., validity area specific SRS configuration) when the area-specific time alignment timer expires. In legacy, when a cell-specific time alignment timer expires, the MAC entity of the UE may notify the RRC layer to release a positioning SRS configuration. However, when the area-specific time alignment timer expires, whether to release the validity area specific SRS configuration needs to be further considered.

Issue #3 is how to deal with the relationship between the area-specific time alignment timer and the cell-specific time alignment timer and how to determine the maintenance of the area-specific time alignment timer and the cell-specific time alignment timer. For example, in a wireless communication system, the area-specific time alignment timer and the cell-specific time alignment timer may be both supported, but the relationship between the two timers for positioning SRS transmission is unclear. Given this, the interaction/maintenance of the two timers should be considered.

Issue #4 is how to determine an SRS configuration to be used by the UE when multiple SRS configurations for multiple SRS validity areas are configured for the UE. For example, the network may provide multiple SRS configurations for multiple SRS validity areas simultaneously, and the principles for the UE to determine which SRS configuration to be used and switch between different SRS configurations need to be defined.

Embodiments of the present disclosure provide solutions for SRS configuration with validity area, which can solve at least one of the above issues. More details will be described in the following text in combination with the appended drawings.

FIG. 3 illustrates a flowchart of an exemplary method performed by a UE and a BS in accordance with aspects of the present disclosure. Although the method is illustrated in a system level by a UE and a BS (e.g., UE 104 and NE 102 as illustrated in FIG. 1), persons skilled in the art can understand that the method implemented in the UE and that implemented in the BS can be separately implemented and incorporated by other apparatus with the like functions. In some implementations, the UE may execute a set of instructions to control functional elements of the UE to perform the described operations or functions. In some implementations, the BS may execute a set of instructions to control functional elements of the BS to perform the described operations or functions.

As shown in FIG. 3, in step 302, the BS may transmit a first configuration to a UE. The first configuration may include (or indicate) an area-specific time alignment timer (e.g., denoted as inactivePosSRSArea-TimeAlignmentTimer) associated with an SRS validity area. Consequently, in step 304, the UE may receive the first configuration from the BS.

In step 306, the UE may transmit an indication to acquire, activate, or deactivate a second configuration associated with the SRS validity area when the UE is in a non-connected state. The non-connected state may be an RRC_INATCIVE state or an RRC_IDLE state. The second configuration includes an SRS configuration, or a time alignment configuration, or a TA command. Consequently, in step 308, the BS may receive the indication from the UE when the UE is in the non-connected state.

Implementations of the illustrated method may include, but are not limited to, the following embodiments that illustrate the details of steps 302-308 in different cases.

### Embodiment 1

The solutions in Embodiment 1 may solve, for example, the aforementioned Issue #1.

In Embodiment 1, the first configuration transmitted by the BS in step 302 and received by the UE in step 304 may include (or indicate) an SRS configuration with an SRS validity area, e.g., the SRS configuration may include SRS validity area information indicating the SRS validity area. The first configuration may also include (or indicate) an area-specific time alignment timer associated with the SRS configuration (thus also associated with the SRS validity area). For example, the first configuration may include an area-specific time alignment configuration indicating the area-specific time alignment timer. In some examples, the SRS configuration may indicate or include the area-specific time alignment timer. In some other examples, the SRS configuration may not indicate or include the area-specific time alignment timer.

The SRS validity area may include one or more cells (e.g., a list of cells) in which the SRS configuration is valid. The area-specific time alignment timer may control the validity area specific SRS transmission (e.g., the SRS transmission within the SRS validity area). For example, the area-specific time alignment timer may control how long an MAC entity of the UE considers the SRS transmission within the SRS validity area to be uplink time aligned.

In some embodiments, the first configuration may be transmitted by the BS and received by the UE via an RRC release message (e.g., RRCRelease as specified in TS 38.331). In some embodiments, the first configuration may be transmitted by the BS and received by the UE via a posSIB message.

In Embodiment 1, the indication transmitted by the UE in step 306 and received by the BS in step 308 may be an indication to acquire a TA command. That is, the second configuration may include the TA command.

In some embodiments, the indication to acquire the TA command may be an uplink request, e.g., an SRS activation request, an SRS configuration request, an SRS configuration update request, etc. In some embodiments, the uplink request may be transmitted via: MSG1 in a 4-step random access procedure, MSG3 in a 4-step random access procedure, MSGA in a 2-step random access procedure, or an accompanying MAC control element (CE) for MSG1, MSG3, or MSGA.

In response to receiving the uplink request, the BS may transmit, to the UE, the TA command for a random access procedure that is successfully completed. In some embodiments, the TA command may be transmitted within a downlink (DL) message, e.g., via MSG2 in a 4-step random access procedure when the uplink request is transmitted via MSG1 of the 4-step random access procedure or an accompanying MAC CE, via MSG4 in a 4-step random access procedure when the uplink request is transmitted via MSG3 of the 4-step random access procedure or an accompanying MAC CE, or via MSGB of a 2-step random access procedure when the uplink request is transmitted via MSGA of the 2-step random access procedure or an accompanying MAC CE.

In some embodiments, e.g., when no SRS activation request or SRS configuration (updated) request is initiated, the indication to acquire the TA command may be a TA command request.

As an embodiment, the TA command request may be transmitted periodically by the UE based on a periodicity. The periodicity may be configured or pre-configured to the UE by the BS, or be pre-defined.

As another embodiment, the TA command request may be transmitted by the UE based on an event. For example, when the event occurs or is detected by the UE, the UE may transmit the TA command request. The event may be configured or pre-configured to the UE by the BS, or be pre-defined.

For example, the event may be that a difference of an RSRP value relative to a reference value is greater than a first threshold within a first time period. The first threshold and/or the first time period may be configured or pre-configured to the UE by the BS, or may be pre-defined. The UE may store an RSRP value as the reference value when it receives a time alignment configuration (e.g., area-specific time alignment configuration).

As another example, the event may be that a moving speed of the UE is greater than a second threshold within a second time period. The second threshold and/or the second time period may be configured or pre-configured to the UE by the BS, or may be pre-defined.

As yet another embodiment, the TA command request may be transmitted based on the UE's implementation.

In response to receiving the TA command request, the BS may transmit the TA command to the UE.

In some embodiments, the UE may monitor the TA command from the BS (which is the serving BS of the UE) within a time period after performing each SRS transmission.

In some cases of Embodiment 1, in response to receiving the TA command from the BS, the UE (e.g., the MAC entity of the UE) may start or restart the area-specific time alignment timer. For example, the UE may start or restart the area-specific time alignment timer if there is ongoing positioning SRS transmission in the non-connected state. The BS may perform similar operations. For example, in response to transmitting the TA command, the BS (e.g., the MAC entity of the BS) may start or restart the area-specific time alignment timer.

In some cases of Embodiment 1, the BS may transmit an indication to start the area-specific time alignment timer. For example, the indication may be transmitted via an RRC signaling. In response to receiving the indication, the UE (e.g., the MAC entity of the UE) may start or restart the area-specific time alignment timer. For example, after an upper layer (e.g., RRC layer) of the UE receives the indication from the BS, the upper layer of the UE may transmit an indication, to the MAC entity of the UE, to start the area-specific time alignment timer, and the MAC entity may start or restart the area-specific time alignment timer in response to receiving the indication from the upper layer of the UE.

In some cases of Embodiment 1, the BS may transmit an indication to stop the area-specific time alignment timer. For example, the indication may be transmitted via an RRC signaling (e.g., an RRCResume message or an RRCSetup message as specified in TS 38.331). In response to receiving the indication, the UE (e.g., the MAC entity of the UE) may stop the area-specific time alignment timer. For example, after an upper layer (e.g., RRC layer) of the UE receives the indication from the BS, the upper layer of the UE may transmit, to the MAC entity of the UE, an indication to stop the area-specific time alignment timer, and the MAC entity may stop the area-specific time alignment timer in response to receiving the indication from the upper layer of the UE.

### Embodiment 2

The solutions in Embodiment 2 may solve, for example, the aforementioned Issue #2.

All the definitions regarding the first configuration transmitted by the BS in step 302 and received by the UE in step 304 as provided in Embodiment 1 may also apply in Embodiment 2, which are omitted here for simplicity.

In some cases of Embodiment 2, when the area-specific time alignment timer expires, the UE may stop the SRS transmission, but the SRS configuration is not released.

In some examples, in step 306, the UE may transmit the indication in response to expiration of the area-specific time alignment timer and the SRS configuration being unreleased. In these examples, the indication may be a deactivation request to deactivate the unreleased SRS configuration. That is, the second configuration may include the unreleased SRS configuration.

For example, the deactivation request may be transmitted via: MSG1 in a 4-step random access procedure, MSG3 in a 4-step random access procedure, MSGA in a 2-step random access procedure, an accompanying MAC CE for MSG1, MSG3, or MSGA, or a small data transmission (SDT) procedure.

In response to receiving the deactivation request from the UE, the BS may transmit, to the UE, a deactivation response to deactivate the unreleased SRS configuration. The deactivation response may be transmitted via MSG2 in a 4-step random access procedure when the deactivation request is transmitted via MSG1 of the 4-step random access procedure, via MSG4 in a 4-step random access procedure when the deactivation request is transmitted via MSG3 of the 4-step random access procedure, via MSGB of the 2-step random access procedure when the deactivation request is transmitted via MSGA of the 2-step random access procedure, or via an accompanying MAC CE for MSG2, MSG4, or MSGB when the deactivation request is transmitted via an accompanying MAC CE for MSG1, MSG3, or MSGA. In response to receiving the deactivation response, the UE may deactivate the unreleased SRS configuration. The BS may also deactivate the unreleased SRS configuration.

In some examples, the UE and the BS may release the unreleased SRS configuration when there is no SRS transmission during a time period after the area-specific time alignment timer expires. The time period may be configured to the UE by the BS (e.g., indicated by the first configuration or the SRS configuration in the first configuration), or may be pre-configured to the UE by the BS, or may be pre-defined.

In some examples, in step 306, the UE may transmit the indication in the case that the area-specific time alignment timer expires and an SRS configuration is unreleased, wherein the indication is an activation request to activate an unreleased SRS configuration. That is, the second configuration may include an unreleased SRS configuration.

For example, the activation request may be transmitted via: MSG1 in a 4-step random access procedure, MSG3 in a 4-step random access procedure, MSGA in a 2-step random access procedure, an accompanying MAC CE for MSG1, MSG3, or MSGA, or an SDT procedure.

In response to receiving the activation request from the UE, the BS may transmit, to the UE, an activation response to activate an unreleased SRS configuration. The activation response in response to the activation request may be transmitted via MSG2 in a 4-step random access procedure when the activation request is transmitted via MSG1 of the 4-step random access procedure, via MSG4 in a 4-step random access procedure when the activation request is transmitted via MSG3 of the 4-step random access procedure, via MSGB of the 2-step random access procedure when the activation request is transmitted via MSGA of the 2-step random access procedure, or via an accompanying MAC CE for MSG2, MSG4, or MSGB when the activation request is transmitted via an accompanying MAC CE for MSG1, MSG3, or MSGA. In response to receiving the activation response, the UE may activate the unreleased SRS configuration. The BS may also activate the unreleased SRS configuration.

As an example, the activation request may indicate the unreleased SRS configuration (e.g., include an index or an identity or a detailed parameter list of the unreleased SRS configuration) and a cause value (e.g., the area-specific time alignment timer expires). In such example, the activation response may be an ACK which indicates to activate the unreleased SRS configuration indicated by the activation request.

As another example, the activation request may be initiated in response to a service. In such example, since the BS may need to know which SRS configuration is suitable for the service, the activation request may indicate a service type or a QoS requirement to assist the BS to determine an unreleased SRS configuration to activate. In such example, the activation response may indicate an unreleased SRS configuration (e.g., include an index of the unreleased SRS configuration) to activate, and then the UE and the BS may activate the unreleased SRS configuration indicated by the activation response.

In some examples, in step 306, the UE may transmit the indication in the case that the area-specific time alignment timer expires and an SRS configuration is unreleased, wherein the indication is a request to acquire a time alignment configuration which indicates another area-specific time alignment timer. That is, the second configuration may include a time alignment configuration.

In response to receiving the request from the UE, the BS may transmit, to the UE, the time alignment configuration indicating another area-specific time alignment timer. The time alignment configuration in response to the request may be transmitted via an RRC signaling, e.g., RRCRelease message.

As an example, the another area-specific time alignment timer may be used for an unreleased SRS configuration. In such example, the request may indicate the unreleased SRS configuration and a cause value (e.g., the area-specific time alignment timer expires).

As an example, in response receiving the request from the UE, the BS may further transmit, to the UE, a time alignment configuration which indicates another area-specific time alignment timer. In addition, a new TA command is also transmitted along with the time alignment configuration. In response to receiving the new TA command, the UE may start the another area-specific time alignment timer.

In some examples, in the case that the area-specific time alignment timer expires, the BS may transmit a paging message to the UE to page the UE. The paging message may include a paging cause value (e.g., the area-specific time alignment timer expires). After receiving the paging message, in step 306, the UE may transmit the indication to the BS, wherein the indication is a request (e.g., via an RRCResumerequest message as specified in TS 38.331) to acquire a time alignment configuration which indicates another area-specific time alignment timer. That is, the second configuration may include a time alignment configuration.

In response to receiving the request from the UE, the BS may transmit, to the UE, the time alignment configuration indicating another area-specific time alignment timer.

In some other cases of Embodiment 2, in response to expiration of the area-specific time alignment timer, the UE may stop the SRS transmission and release the SRS configuration.

In some examples, in the case that there is a pending location service (e.g., after expiration of the area-specific time alignment timer or when the UE is out of the SRS validity area), in step 306, the UE may transmit the indication to the BS, wherein the indication is a request (e.g., via an RRCResumerequest message as specified in TS 38.331) to acquire a new SRS configuration (i.e., update the SRS configuration). The request to acquire a new SRS configuration may indicate a cause value. The cause value may be: the area-specific time alignment timer expires, out of the SRS validity area, etc. In response to receiving the request, the BS may provide a new SRS configuration to the UE. A new time alignment configuration may also be provided to the UE with the new SRS configuration.

### Embodiment 3

In some cases, an area-specific time alignment timer and a cell-specific time alignment timer may be both supported in a system. Embodiment 3 provides solutions in such cases. That is, the solutions in Embodiment 3 may solve, for example, the aforementioned Issue #3.

In some cases of Embodiment 3, the UE may maintain only one of an area-specific time alignment timer and a cell-specific time alignment timer at the same time based on a received SRS configuration. For example, in the case that an SRS configuration (e.g., a validity area specific SRS configuration) associated with an SRS validity area is received, the UE only starts or restarts the area-specific time alignment timer when it receives a TA command or an indication to start a time alignment timer from the BS. As another example, in the case that a cell specific SRS configuration is received, the UE only starts or restarts the cell-specific time alignment timer when it receives a TA command or an indication to start a time alignment timer from the BS. The BS may perform similar operations. That is, the BS may maintain only one of an area-specific time alignment timer and a cell-specific time alignment timer at the same time based on a transmitted SRS configuration.

In some examples, the UE may invalidate a cell-specific time alignment configuration (which may indicate a cell-specific time alignment timer) in response to receiving an area-specific time alignment configuration (which may indicate an area-specific time alignment timer).

In some examples, a UE (e.g., a UE with LPHAP capability) is not allowed to be configured with cell-specific SRS and area-specific SRS at the same time. In such examples, the BS may not transmit a cell specific SRS configuration and a validity area specific SRS configuration at the same time; and the UE may not receive a cell specific SRS configuration and a validity area specific SRS configuration at the same time.

In some examples, a UE (e.g., a UE with LPHAP capability) is not allowed to activate a cell specific SRS configuration and a validity area specific SRS configuration at the same time if they are both configured. In such examples, the BS also may not activate a cell specific SRS configuration and a validity area specific SRS configuration at the same time.

In some cases of Embodiment 3, an SDT procedure may be triggered for an uplink transmission. In such cases, the UE may star or restart a SDT time alignment timer (e.g., cg-SDT-TimeAlignmentTimer as specified in TS 38.321). The SDT time alignment timer is independent from the area-specific time alignment timer and the cell-specific time alignment timer. That is, operations with respect to the SDT time alignment timer are independent from the area-specific time alignment timer and the cell-specific time alignment timer.

In some cases of Embodiment 3, the UE may maintain an area-specific time alignment timer and a cell-specific time alignment timer simultaneously.

In such cases, the first configuration transmitted by the BS in step 302 and received by the UE in step 304 may include an SRS configuration with SRS validity area including a list of cells (e.g., including cell #1, cell #2, and cell #3) and an area-specific time alignment timer (e.g., defined as inactivePosSRSArea-TimeAlignmentTimer) associated with the SRS validity area. In addition to the first configuration, the BS may transmit, to the UE, a third configuration indicating a cell-specific time alignment timer (e.g., inactivePosSRS-TimeAlignmentTimer or cg-SDT-TimeAlignmentTimer as specified in TS 38.321) associated with a cell (e.g., cell #1) in the list of cells.

As an example, the UE may start or restart the area-specific time alignment timer and the cell-specific time alignment timer simultaneously in response to receiving a TA command or an indication for starting a time alignment timer (the area-specific time alignment timer or the cell-specific time alignment timer) from the BS. The BS may perform similar operations. For example, the BS may start or restart the area-specific time alignment timer and the cell-specific time alignment timer simultaneously in response to transmitting a TA command or an indication for starting a time alignment timer to the UE.

As another example, when the cell-specific time alignment timer expires but the area-specific time alignment timer is running, the UE may perform at least one of the followings: continuing an SRS transmission; determining an UL unsynchronization for cell specific UL transmission(s); stopping all cell specific UL transmission(s); or initiating a TA command update (e.g., by transmitting a request for a TA command) or requesting a cell-specific time alignment configuration (e.g., by transmitting a request for a cell-specific time alignment configuration) when a cell specific UL transmission (e.g., UL data arrival, UL feedback caused by DL data, etc.) occurs. The BS may perform the corresponding operations. For example, the BS may receive a request for a TA command or a request for a cell-specific time alignment configuration, and transmit the corresponding response to the UE.

As another example, the UE may reselect to a new cell (e.g., cell #2) within the SRS validity area and different from the cell (e.g., cell #1) associated with the cell-specific time alignment timer, the UE may stop or restart the cell-specific time alignment timer, and keep the area-specific time alignment timer running. The BS may perform similar operations.

As another example, when the area-specific time alignment timer expires, the UE may stop the SRS transmission. The UE may also stop the cell-specific time alignment timer if it is still running. The BS may perform similar operations. For example, the BS may stop the cell-specific time alignment timer.

### Embodiment 4

The solutions in Embodiment 4 may solve, for example, the aforementioned Issue #4.

In Embodiment 4, the first configuration transmitted by the BS in step 302 and received by the UE in step 304 may include (or indicate) multiple SRS configurations for (or associated with) multiple SRS validity areas. An SRS configuration of the multiple SRS configurations may include or not include validity area information indicating an SRS validity area associated with the SRS configuration. For example, the first configuration may include three SRS configurations with validity area information (e.g., denoted as srsconfig1-areal, srsconfig2-area2, and srsconfig3-area3) or without validity area information (e.g., denoted as srsconfig1, srsconfig2, and srsconfig3). For each SRS configuration of the multiple SRS configurations, the first configuration may also include a corresponding area-specific time alignment timer associated with the SRS configuration.

Embodiment 4 may be divided into Embodiment 4-1 and Embodiment 4-2.

### Embodiment 4-1

In Embodiment 4-1, the first configuration may be transmitted by the BS to the UE via an RRC release message (e.g., an RRCRelease message as specified in TS 38.331).

In an embodiment, the first configuration may also indicate an SRS configuration of the multiple SRS configurations which is used by the UE. For example, the first configuration may include an index or an ID of an SRS configuration used by the UE.

In another embodiment, each SRS configuration of the multiple SRS configurations may include validity area information indicating a corresponding SRS validity area. The UE or the BS may determine an SRS configuration of the multiple SRS configurations which is used by the UE based on a cell ID and validity area information of the multiple SRS configurations indicating the multiple SRS validity areas. For example, if three SRS configurations with validity area information (e.g., denoted as srsconfig1-areal, srsconfig2-area2, and srsconfig3-area3) are configured to the UE, and areal includes a cell list which includes cell #1, cell #2, and cell #3, in the case that the UE camps in cell #1, the UE may determine to use srsconfig1-areal from the multiple SRS configurations.

### Embodiment 4-2

In Embodiment 4-2, the first configuration may be transmitted by the BS to the UE via a posSIB message.

After receiving the first configuration including the multiple SRS configurations, in step 306, the UE may transmit the indication to the BS, and the BS may receive the indication in step 308, wherein the indication may be an activation request to activate an SRS configuration of the multiple SRS configurations

In some examples, the BS may transmit an activation response in response to the activation request to the UE. The activation response may indicate an SRS configuration of the multiple SRS configurations and a TA command used by the UE. For example, the activation response may include an index or an ID of the SRS configuration.

In some examples, the activation request may indicate an SRS configuration of the multiple SRS configurations. For example, the activation response may include an index or an ID of the SRS configuration.

In the case that the indicated SRS configuration is available, the BS may transmit an ACK in response to the activation request. After receiving the ACK in response to the activation request, the UE may activate the indicated SRS configuration.

In the case that the indicated SRS configuration is unavailable, the BS may transmit an activation response in response to the activation request, wherein the activation response may indicate a new SRS configuration of the multiple SRS configuration which is different from the indicated SRS configuration. In some examples, the activation response may also include a TA command used by the UE. After receiving the activation response, the UE may activate the new SRS configuration.

The activation request transmitted by the UE may indicate a cause value, for example, the cause value may be: the area-specific time alignment timer expires, out of the SRS validity area, etc.

In some examples, the activation request may be transmitted via: MSG1 in a 4-step random access procedure, MSG3 in a 4-step random access procedure, MSGA in a 2-step random access procedure, an RRC signaling, or an UL MAC CE for MSG1, MSG3, or MSGA. The ACK or activation response in response to the activation request may be transmitted via MSG2 in a 4-step random access procedure when the activation request is transmitted via MSG1 of the 4-step random access procedure, via MSG4 in a 4-step random access procedure when the activation request is transmitted via MSG3 of the 4-step random access procedure, via MSGB of the 2-step random access procedure when the activation request is transmitted via MSGA of the 2-step random access procedure, via an RRC signaling when the activation request is transmitted via an RRC signaling, or via a DL MAC CE for MSG2, MSG4, or MSGB when the activation request is transmitted via the UL MAC CE for MSG1, MSG3, or MSGA.

In some examples, when the UE moves out of a current SRS validity area or a current SRS configuration is invalid (e.g., the area-specific time alignment timer expires), the UE needs to activate a new SRS configuration from the multiple SRS configurations. All the above operations described above in Embodiment 4-2 may also apply here for the UE to activate a new SRS configuration.

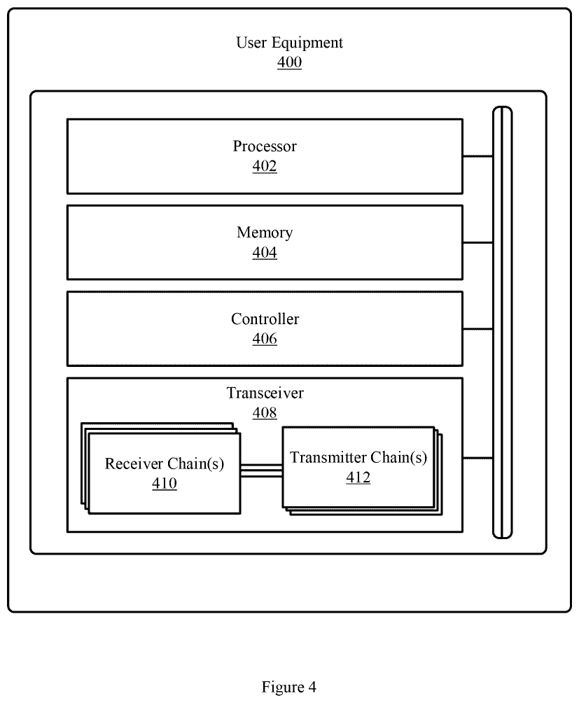

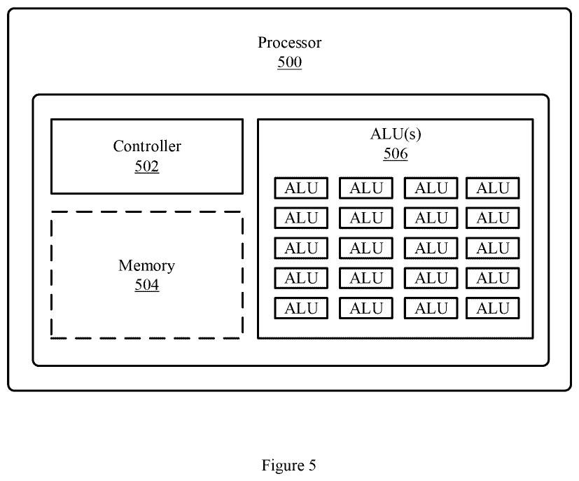

FIG. 4 illustrates an example of a UE 400 in accordance with aspects of the present disclosure. The UE 400 may include at least one processor 402 and at least one memory 404. Additionally, the UE 400 may also include one or more of at least one controller 406 or at least one transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for performing the operations of the methods described in the embodiments of the present disclosure. In an embodiment, the processor 402 may be configured to cause the UE 400 to: receive a first configuration including an area-specific time alignment timer associated with an SRS validity area; and transmit an indication to acquire, activate, or deactivate a second configuration associated with the SRS validity area when the UE is in a non-connected state, wherein the second configuration includes an SRS configuration, or a time alignment configuration, or a TA command.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, a layer 1 (L1), layer 2 (L2), or layer 3 (L3) cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs, and other functional units of the processor 500.

The memory 504 may include one or more caches (e.g., memory local to or included in the processor 500 or other memory, such RAM, ROM, DRAM, SDRAM, SRAM, MRAM, flash memory, etc.). In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for performing the operations of the methods described in the embodiments of the present disclosure. In an embodiment, the controller 502 may cause the processor 500 to: receive a first configuration including an area-specific time alignment timer associated with an SRS validity area; and transmit an indication to acquire, activate, or deactivate a second configuration associated with the SRS validity area when a UE including the processor 500 is in a non-connected state, wherein the second configuration includes an SRS configuration, or a time alignment configuration, or a TA command.

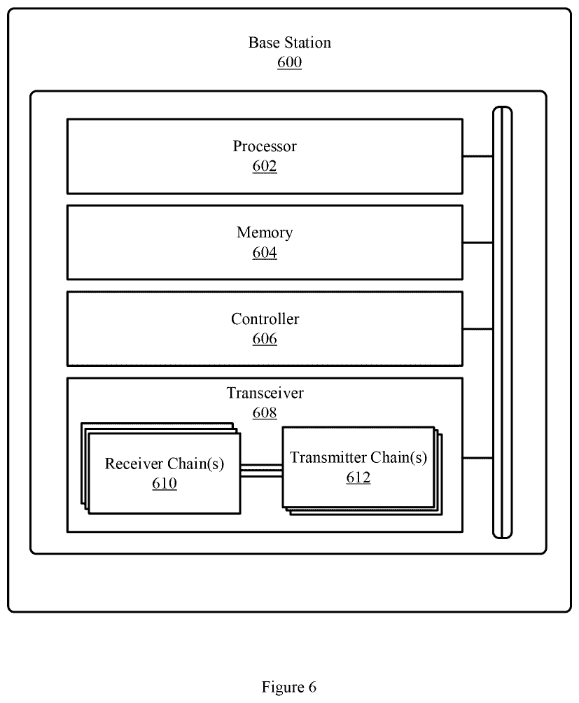

FIG. 6 illustrates an example of a BS 600 in accordance with aspects of the present disclosure. The BS 600 may include at least one processor 602 and at least one memory 604. Additionally, the BS 600 may also include one or more of at least one controller 606 or at least one transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the BS 600 to perform various functions of the present disclosure.

The memory 604 may include volatile or non-volatile memory. The memory 604 may store computer-readable, computer-executable code including instructions when executed by the processor 602 cause the BS 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the BS 600 to perform one or more of the functions described herein (e.g., executing, by the processor 602, instructions stored in the memory 604). For example, the processor 602 may support wireless communication at the BS 600 in accordance with examples as disclosed herein. The BS 600 may be configured to support a means for performing the operations of the methods described in the embodiments of the present disclosure. In an embodiment, the processor 602 may be configured to cause the BS 600 to: transmit, to a UE, a first configuration including an area-specific time alignment timer associated with an SRS validity area; and receive an indication to acquire, activate, or deactivate a second configuration associated with the SRS validity area when the UE is in a non-connected state, wherein the second configuration includes an SRS configuration, or a time alignment configuration, or a TA command.

The controller 606 may manage input and output signals for the BS 600. The controller 606 may also manage peripherals not integrated into the BS 600. In some implementations, the controller 606 may utilize an operating system such as iOS®, ANDROID®, WINDOWS®, or other operating systems. In some implementations, the controller 606 may be implemented as part of the processor 602.

In some implementations, the BS 600 may include at least one transceiver 608. In some other implementations, the BS 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a first configuration including an area-specific time alignment timer associated with a sounding reference signal (SRS) validity area; and
transmit an indication to acquire, activate, or deactivate a second configuration associated with the SRS validity area when the UE is in a non-connected state, wherein the second configuration includes an SRS configuration, a time alignment configuration, or a timing advance (TA) command.

2. (canceled)

3. (canceled)

4. (canceled)

5. The UE of claim 1, wherein the at least one processor is further configured to cause the UE to:
start or restart the area-specific time alignment timer in response to receiving an indication for starting the area-specific time alignment timer; or
stop the area-specific time alignment timer in response to receiving an indication for stopping the area-specific time alignment timer.

6. The UE of claim 1, wherein the at least one processor is further configured to cause the UE to:
transmit the indication in response to expiration of the area-specific time alignment timer and an SRS configuration being unreleased, wherein the indication is a deactivation request to deactivate the unreleased SRS configuration;
receive, in response to the deactivation request, a deactivation response to deactivate the unreleased SRS configuration; and
deactivate the unreleased SRS configuration.

7. The UE of claim 1, wherein the at least one processor is further configured to cause the UE to:
transmit the indication when the area-specific time alignment timer expires and an SRS configuration is unreleased, wherein the indication is an activation request to activate the unreleased SRS configuration, and wherein the activation request indicates:
the unreleased SRS configuration and a cause value; or
a service type or a quality of service (QoS) requirement.

8. The UE of claim 1, wherein the at least one processor is further configured to cause the UE to:
transmit the indication when the area-specific time alignment timer expires and an SRS configuration is unreleased, wherein the indication is a request to acquire the time alignment configuration, which indicates another area-specific time alignment timer, and wherein the request indicates the unreleased SRS configuration and a cause value.

9. The UE of claim 1, wherein the at least one processor is further configured to cause the UE to:
receive a paging message when the area-specific time alignment timer expires; and
transmit the indication after receiving the paging message, wherein the indication is a request to acquire the time alignment configuration, which indicates another area-specific time alignment timer.

10. The UE of claim 1, wherein the at least one processor is further configured to cause the UE to:
stop an SRS transmission and release an SRS configuration in response to expiration of the area-specific time alignment timer.

11. The UE of claim 1, wherein the at least one processor is further configured to cause the UE to:
maintain one of the area-specific time alignment timer and or a cell-specific time alignment timer at the same time based on a received SRS configuration;
invalidate a cell-specific time alignment configuration in response to receiving the first configuration;
not receive a cell specific SRS configuration and a validity area specific SRS configuration at the same time; or
not activate a cell specific SRS configuration and a validity area specific SRS configuration at the same time.

12. The UE of claim 1, wherein the at least one processor is further configured to cause the UE to:
receive a third configuration indicating a cell-specific time alignment timer; and
start or restart the area-specific time alignment timer and the cell-specific time alignment timer simultaneously in response to receiving a TA command or an indication for starting the area-specific time alignment timer or the cell-specific time alignment timer.

13. The UE of claim 12, wherein, when the cell-specific time alignment timer expires while the area-specific time alignment timer is running, the at least one processor is further configured to cause the UE to:
continue an SRS transmission;
determine an uplink (UL) unsynchronization for one or more cell specific UL transmissions;
stop all cell specific UL transmissions; or
initiate a TA command update or request a cell-specific time alignment configuration when a cell specific UL transmission occurs.

14. The UE of claim 12, wherein, when the area-specific time alignment timer expires, the at least one processor is further configured to cause the UE to:
stop an SRS transmission; and
stop the cell-specific time alignment timer.

15. The UE of claim 1, wherein the first configuration further indicates multiple SRS configurations for multiple SRS validity areas and is received via a radio resource control (RRC) release message.

16. The UE of claim 15, wherein the indication is an activation request to activate an SRS configuration of the multiple SRS configurations.

17. The UE of claim 16, wherein the at least one processor is further configured to cause the UE to receive an activation response in response to the activation request, wherein the activation response indicates an SRS configuration of the multiple SRS configurations and a TA command used by the UE; or
wherein the activation request indicates the SRS configuration, and the at least one processor is further configured to cause the UE to:
receive an acknowledgement (ACK) in response to the activation request when the indicated SRS configuration is available; or
receive an activation response in response to the activation request, wherein the activation response indicates a different SRS configuration of the multiple SRS configurations when the indicated SRS configuration is unavailable; or
wherein the activation request indicates a cause value.

18. A processor for wireless communication, comprising:
at least one controller coupled with at least one memory and configured to cause the processor to:
receive a first configuration including an area-specific time alignment timer associated with a sounding reference signal (SRS) validity area; and
transmit an indication to acquire, activate, or deactivate a second configuration associated with the SRS validity area when a user equipment including the processor is in a non-connected state, wherein the second configuration includes an SRS configuration, or a time alignment configuration, or a timing advance (TA) command.

19. A base station (BS) for wireless communication, comprising:
at least one memory; and
at least one processor coupled with the at least one memory and configured to cause the BS to:
transmit, to a user equipment (UE), a first configuration including an area-specific time alignment timer associated with a sounding reference signal (SRS) validity area; and
receive an indication to acquire, activate, or deactivate a second configuration associated with the SRS validity area when the UE is in a non-connected state, wherein the second configuration includes an SRS configuration, or a time alignment configuration, or a timing advance (TA) command.

20. A method performed by a user equipment (UE), the method comprising:
receiving a first configuration including an area-specific time alignment timer associated with a sounding reference signal (SRS) validity area; and
transmitting an indication to acquire, activate, or deactivate a second configuration associated with the SRS validity area when the UE is in a non-connected state, wherein the second configuration includes an SRS configuration, or a time alignment configuration, or a timing advance (TA) command.

21. The UE of claim 1, wherein the at least one processor is further configured to cause the UE to: in response to receiving the TA command, start or restart the area-specific time alignment timer.

22. The UE of claim 5, wherein, to start or restart the area-specific time alignment timer, the at least one processor is configured to cause the UE to:
start or restart the area-specific time alignment timer via a media access control (MAC) entity of the UE in response to receiving the indication from an upper layer of the UE.

23. The UE of claim 5, wherein, to stop the area-specific time alignment timer, the at least one processor is configured to cause the UE to:
stop the area-specific time alignment timer via a media access control (MAC) entity of the UE in response to receiving the indication from an upper layer of the UE.
